(19) United States
(12) Patent Application Publication
(10) Pub. No.: US 2008/0257983 A1
(43) Pub. Date: Oct. 23, 2008

(54) Hose Anti-Twist Strip

(76) Inventor: Donald Robert Martin Boys, Redding, CA (US)

Correspondence Address: CENTRAL COAST PATENT AGENCY, INC, 3 HANGAR WAY SUITE D, WATSONVILLE, CA, 95076, US

(21) Appl. No.: 12/104,813

(22) Filed: Apr. 17, 2008

Related U.S. Application Data
(60) Provisional application No. 60/912,567, filed on Apr. 18, 2007.

(51) Int. Cl. F16L 3/12

(52) U.S. Cl. 239/276; 248/71; 248/74.5

(57) ABSTRACT

A tool is provided for maintaining alignment of watering heads installed on a conduit comprising a pliable elongate strip of a length suitable to overlap the outside diameter of a conduit, a catch sleeve affixed to one end of the strip, the catch sleeve for accepting the other end of the strip and retaining that end of the strip, a plurality of gripping elements strategically located on one surface of the strip that interfaces with the outer surface of the conduit, and a stake sleeve affixed to a surface opposite the surface supporting the gripping elements.

### CROSS-REFERENCE TO RELATED APPLICATIONS

The present invention claims priority to a U.S. provisional patent application Ser. No. 60/912,567, filed on Apr. 18, 2007, entitled “Conduit-Gripping Strip for Twist Correction”, disclosure of which is incorporated in its entirety.

### BACKGROUND OF THE INVENTION

1. Field of the Invention

The present invention is in the field of horticultural tools and accessories and pertains particularly to tools for correcting twisting in conduits.

2. Discussion of the State of the Art

In horticulture, there is a growing segment of the market that practices horticulture by setting up their own drip or spray watering systems to water their flower or vegetable gardens. Several brands of “do-it-yourself” watering systems are available on the market. These systems use a plastic conduit about 0.5″ in diameter as main watering conduit. A host of accessories and tools are available for fashioning a durable drip or sprinkler system using the conduit as a main delivery conduit for the water.

Directional sprinkler heads are available with threaded stem that can be installed directly to the conduit using a punch tool provided to make a starter hole in the conduit where the desired watering head is then threaded into the hole to secure the installation.

Over a length of conduit, a number of watering heads may be installed for providing a direction spray or mist onto the intended plants that are watered by the system.

A problem with the system is that the conduit tends to develop twisting along its length due to hot and then cool weather cycles. At times the twisting is severe enough to force the installed watering heads out of vertical alignment. The inventor is aware of an anti-hose twist clamp that can be used to correct or prevent hose twist in the plastic conduit. The clamp is made of plastic and includes two annular halves hinged together that can be closed over the conduit and latched in place. The inside surface of the clamping elements has gripping elements that bite slightly into the hose preventing the hose from moving or turning within the clamp.

The clamp can be staked down when installed in position, typically next to a watering head to prevent that part of the conduit from twisting thus maintaining the vertical alignment of the watering head. Likewise, the clamp can be applied next to watering heads that have already lost vertical alignment, twisted to correct the alignment and then staked to the ground thereby correcting the developed twist in that part of the conduit. The clamp has two moving parts pinned or hinged at the back and requires a molding process to make the parts economically.

It has occurred to the inventor that there are simpler and less expensive ways to provide a tool that prevents or corrects longitudinal twist in a conduit. Therefore, what is needed is a twist correction device for conduit that can be provided with no significant moving parts.

### SUMMARY OF THE INVENTION

A problem stated above is that current tools for preventing misalignment of watering heads installed on conduits contain moving parts and must be molded using an expensive molding process. The inventor therefore searched horticultural implements looking for components and materials that could be modified or improved to provide alignment retention properties for watering heads installed on conduit without the complexity of moving parts.

Accordingly, a tool is provided for maintaining alignment of watering heads installed on a conduit comprising a pliable elongate strip of a length suitable to overlap the outside diameter of a conduit, a catch sleeve affixed to one end of the strip, the catch sleeve for accepting the other end of the strip and retaining that end of the strip, a plurality of gripping elements strategically located on one surface of the strip that interfaces with the outer surface of the conduit, and a stake sleeve affixed to a surface opposite the surface supporting the gripping elements.

In one aspect the strip is metallic and the gripping elements are formed in the strip by metal stamping and the catch sleeve retains the opposite end of the strip by accepting a tooth pattern formed on the strip edges such that once pressed through the sleeve the teeth are prevented from being retracted from the sleeve.

### BRIEF DESCRIPTION OF THE DRAWING FIGURES

FIG. 1 is a front view of a hose gripping strip according to an embodiment of the present invention.

FIG. 2 is a side view of the strip of FIG. 1.

FIG. 3 is an elevation view of the strip of FIG. 1 installed about a conduit with a stake in place to preserve the alignment of a watering head.

FIG. 4 is side-view of a stake for staking down conduit in an embodiment of the invention.

### DETAILED DESCRIPTION

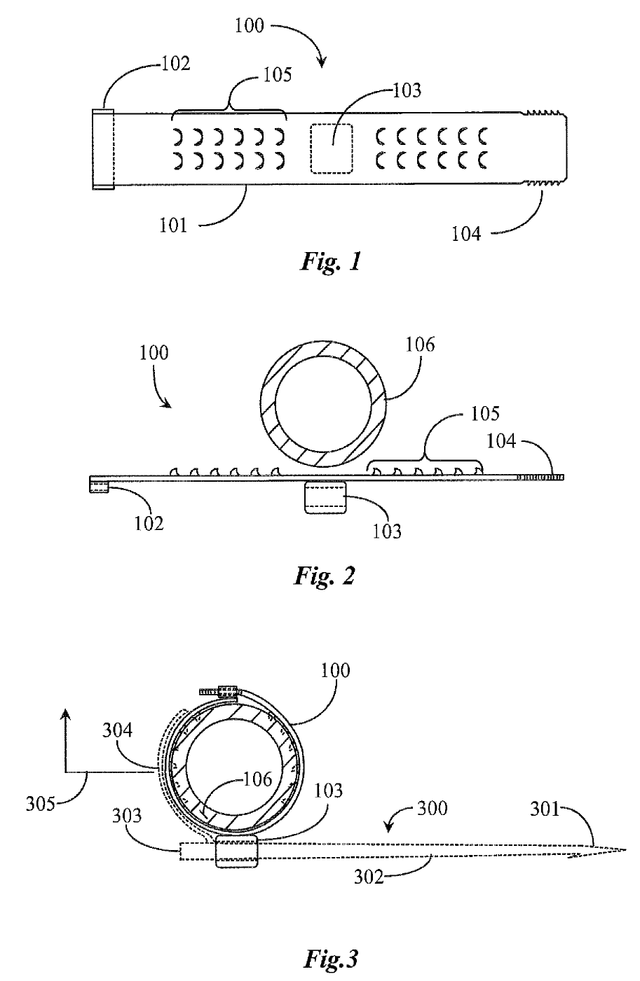

FIG. 1 is a front view of a hose gripping strip 100 according to an embodiment of the present invention. Referring now to FIG. 1, a conduit-gripping strip 100, hereinafter referred to as strip 100 is provided for preventing or for correcting longitudinal twist that can develop in a conduit such as a hose or water line used to water plants for example.

Strip 100 may be manufactured of a durable and pliable sheet metal in the form of an elongated strip having a length suitable for wrapping around a conduit with sufficient overlapping of strip ends. Strip 100 and a thickness dimension small enough to enable enough flexibility in the strip so that it may be manually wrapped around an annular conduit substantially conforming to the periphery of the conduit.

Strip 100 includes a plurality of gripping elements, one group of which is illustrated herein as gripping elements 104 protruding from one surface of the strip. In this example, the gripping elements are teeth formed by stamping the tooth pattern into the metal from the opposite surface to create the protruding element. In this example there are two groups of gripping elements 105 on strip 100. Each group is strategically located in a symmetric pattern on strip 100 so that when the strip is wrapped around a conduit, the gripping elements come into contact with the surface of the conduit biting slightly into the surface of the conduit.

In this example, gripping elements 105 are arranged in two groups of elements where the individual teeth are directionally opposed to one another with respect to an angle of protrusion and therefore the direction of the biting surface of the elements. In another embodiment the gripping elements may all be oriented in a same direction. Moreover, gripping elements 105 may be provided in a random rather than a symmetric pattern and it is not necessary to have two or more distinct groupings of elements.

Strip 100 has a small tooth pattern 104 cut or stamped into the opposing edges of the strip at one end of the strip. The individual teeth of tooth pattern 104 are substantially equally spaced from one another and protrude angularly back from the very end of the strip similar to a pattern of barbs. On the opposite end of strip 100 a catch sleeve is provided for receiving the “barbed” end or the portion thereof that is an overlapping portion after strip 100 has been wrapped around a conduit.

Catch sleeve 102 has an inside width dimension slightly smaller that the outside width dimension of the received end of strip 100 measuring across the strip from tip-to-tip of the tooth patterns on the end of the strip. The inside height dimension of catch sleeve 102 is just larger than the thickness dimension of strip 100 so that the end of the strip opposite the catch sleeve may be inserted through the sleeve. In one embodiment, tooth pattern 104 has individual teeth that are somewhat resilient such that they may be recessed toward the strip edge slightly under force and may then spring back to their original position or near their original position after the force in no longer present. In this embodiment, the tooth bearing end of strip 100 may be forced through catch sleeve 102 wherein the teeth (104) may flex under the force of insertion and spring back once they are past the interior of sleeve 102 thereby catching on the edge of the sleeve at the opposing tooth pair last pushed past the edge causing the strip to be tightly wrapped around the conduit held in place by the teeth against the edge of sleeve 102.

In other embodiments other mechanisms may be employed to enable closing strip 100 around a conduit such that the strip is retained on the conduit with the gripping elements engaged with the conduit surface. For example, in one embodiment instead of a tooth pattern 104, the strip end has opposing longitudinal slots cut in from the strip end toward the direction of the strips main body at a specified length creating opposing prongs at one end of the strip. The prongs then may naturally flare outward somewhat given the resilient properties of the strip material, perhaps spring steel. Small lands may be provided one on each outward facing prong edge such that when the strip end is forced through catch sleeve 102, the prongs flex inward and spring back on the prong lands pass the sleeve opening opposite the insertion opening, thereby retaining the strip around the conduit. In some embodiments, the overall length of strip 100 is specified for the correct diameter of conduit, for example, one specific strip fits a three quarter diameter conduit while a strip of another length fits a conduit of another diameter.

In still another embodiment, depending on the style of mechanism used to close the strip around a conduit, one strip may be designed to accommodate more than one diameter of conduit utilizing some overlap and, perhaps a multi-positional locking mechanism. In use, strip 100 is physically wrapped around the conduit and then staked into the ground preventing the conduit from twisting at that point. For this purpose, a stake sleeve 103 is provided on the back surface of strip 100 for receiving a plastic or metallic stake.

FIG. 2 is a side view of strip 100 of FIG. 1. Referring now to FIG. 2, strip 100 is illustrated in side view to show the directional profile of gripping elements 105. For reference, a cross-section of a conduit 106 is illustrated in a position just before the strip is wrapped around the conduit. In this example, gripping elements 105 exhibit an opposing pattern so that predisposition for longitudinal twist by the conduit is prevented in both directions. The strip of the present invention may be used to correct a misaligned watering element such as a directional sprinkling or spraying head installed directly into the conduit such as is common with many home-garden watering systems. In one case, the grip strip of the invention can be used to correct longitudinal twisting which as occurred in a conduit having multiple watering heads installed thereon where the twisting that has occurred in the conduit has caused misalignment of the heads. This is very common especially when summer days are hot and nights are cool.

FIG. 3 is an elevation view of strip 100 of FIG. 1 installed about a conduit with a stake in place to preserve the alignment of a watering head. Referring now to FIG. 3, strip 100 is illustrated in position wrapped around conduit 106 with the gripping elements engaged into the conduit preventing longitudinal rotation of the conduit relative to the closed grip strip 100. In this example, a stake 300 is illustrated in position through stake sleeve 103. In this example, stake 300 may be manufactured of a durable polymer or a metal. Stake 300 has a tapered stake body 302 that tapers down to a stake tip 301. Tip 301 may be of a barbed or other advantageous configuration to promote resistance to reverse force once the stake is in the ground.

Sleeve 103 is a dimension so that the stake may slide all the way through until the stakes outside dimension makes intimate contact with the sleeves inner dimension. In this example, stake 300 has a steak head 303 adapted for accepting the blows of a mallet, hammer, or the like used to pound it into the ground. Stake 300 also has a conduit cover plate 304 adapted generally to cover the radius of the conduit giving further advantage of holding the conduit in position against the ground.

To correct the alignment of a directional watering head installed directly to conduit 106, logically illustrated herein by a directional arrow 305, the axis formed by the stake sleeve 103 and stake 300 should be positioned substantially perpendicularly to the directional spray axis of the miss-aligned watering head. In this case, the longitudinal twist caused the spray direction of the watering head to point straight upward. Positioning grip strip 100 as shown and described enables the user to manually twist the hose in the correct direction opposite the errant twist and then to stake the conduit to the ground preventing any further twisting. It is noted herein that the location of installation of the strip of the invention is preferably just adjacent to the miss-aligned watering element. The device of the invention may be used to correct longitudinal twisting that has already developed in a garden conduit or other conduit or to prevent any longitudinal twist from developing in the conduit that would result in misalignment of installed apparatus.

In one embodiment of the present invention the anti-twist hose gripping elements of the present invention may be applied to another simple device that is already available as an accessory in some watering systems.

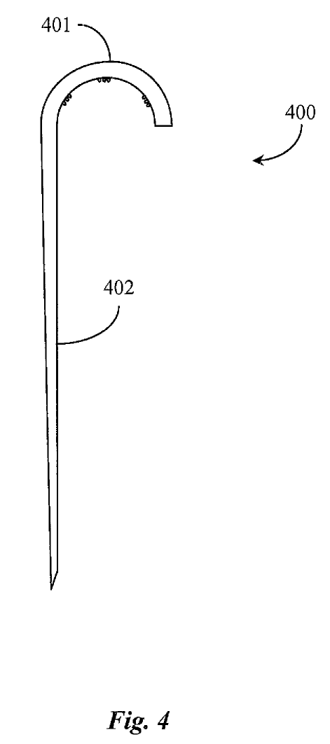

FIG. 4 is side-view of a stake for staking down conduit in such a manner as to prevent or correct twisting in the conduit. An anti-twist conduit stake 400 is provided in one embodiment of the invention. Stake 400 contains no moving parts and can be made of plastic or some other durable material. Stake 400 may be molded in the general shape of a garden stake with a hook portion 401 for catching the conduit and a shaft portion 402 for anchoring the conduit to the ground.

The inward surface of the hook portion 401 of stake 400 has hose gripping elements provided thereon or formed contiguously thereto that function to bite into the conduit slightly to hold the conduit in position and this preventing twisting of the conduit beneath the stake. Like the hose gripping strip described above, stake 400 has no moving parts and can be molded more economically that a tool containing moving parts.

It will be apparent to one with skill in the art that the conduit anti-twist strip of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A tool for maintaining alignment of watering heads installed on a conduit comprising:
a pliable elongate strip of a length suitable to overlap the outside diameter of a conduit;
a catch sleeve affixed to one end of the strip, the catch sleeve for accepting the other end of the strip and retaining that end of the strip;
a plurality of gripping elements strategically located on one surface of the strip that interfaces with the outer surface of the conduit; and
a stake sleeve affixed to a surface opposite the surface supporting the gripping elements.

2. The tool of claim 1 wherein the strip is metallic and the gripping elements are formed in the strip by metal stamping.

3. The tool of claim 1 wherein the catch sleeve retains the opposite end of the strip by accepting a tooth pattern formed on the strip edges such that once pressed through the sleeve the teeth are prevented from being retracted from the sleeve.
